(19) United States
(12) Patent Application Publication
(10) Pub. No.: US 2021/0285842 A1
(43) Pub. Date: Sep. 16, 2021

(54) MACHINE LEAK DETECTION FEATURE AND SERVICE

(71) Applicant: Caterpillar Paving Products Inc., Brooklyn Park, MN (US)

(72) Inventors: Ryan J. Nelson, Maple Grove, MN (US); Terry Stoe, Champlin, MN (US)

(73) Assignee: Caterpillar Paving Products Inc., Brooklyn Park, MN (US)

(21) Appl. No.: 16/819,978

(22) Filed: Mar. 16, 2020

(51) Int. Cl. G01M 3/38; E02F 9/26

(52) U.S. Cl. CPC G01M 3/38; E02F 9/267

(57) ABSTRACT

Machine leak detection in a work machine is disclosed. The work machine may include an operational component containing a work fluid, a work fluid accumulation area proximate the operational component and disposed in a location where the work fluid leaking from the operational component will accumulate, a leak detection mechanism disposed within the work fluid accumulation area and monitoring the work fluid accumulation area for a work fluid leak accumulation, wherein the leak detection mechanism transmits a leak detection sensor signal in response to detecting the work fluid leak accumulation, and a communication module. The work machine may further include a work machine controller programmed to receive the leak detection sensor signal from the leak detection mechanism, and to cause the communication module to transmit a work machine leak detected signal to a work machine monitoring center in response to receiving the leak detection sensor signal.

### TECHNICAL FIELD

The present disclosure relates generally to work machines and, more particularly, to detection of leaks of work fluids in work machines and notifications for operators and work machine monitoring services.

### BACKGROUND

Many operator-driven work machines have been developed for performing excavation operations on work surfaces, such as asphalt pavers, backhoe loaders, cold planers, compactors, bulldozers, drills, excavators, material handlers, motor graders, skid steer and wheel loaders, and the like. Generally, these work machines include one or more work implements mounted on a tractor or other machine body that is moveable along the ground on wheels or tracks. Operation of such work machines requires the use of various work fluids that flow through the components and conduits of the work machine, such as fuel, engine oils, hydraulic fluids and the like.

Currently known work machines generally lack leak detection systems for detecting leaking work fluids. Some work fluid leaks may be minor and do not require immediate attention, but others may indicate critical machine component failures or the potential for severe damage to machine components if the leaks are not are not stopped and the work fluids are not replenished. Without leak detection systems and corresponding notifications to work machine operators and monitoring technicians and systems, operators, maintenance personnel and owners of the work machines are unaware of work fluid leaks during operation unless the work fluid is leaking out of the work machine and onto the work surface, or the operators or maintenance personnel look inside the compartments of the work machine. This poses environmental risks as well as risks to the work machine if work fluid leaks continue undetected and unremedied.

Leak detection has been known in other environments. For example, Japanese Publication No. JPH0635940U, that published on May 13, 1994, entitled “Fluid Leak Inspection Vessel,” discloses a handheld gloss meter sensor having a grip, a connector, lead wires, an amplifier and a buzzer. Light from a light source is directed at an inspection object. Light reflected by a fluid on the surface of the inspection object is received by a light sensor and converted into an electrical signal that is sent to the amplifier to cause sound to be produced by the buzzer.

### SUMMARY OF THE DISCLOSURE

In one aspect of the present disclosure, a work machine is disclosed. The work machine may include an operational component containing a work fluid of the work machine, a work fluid accumulation area proximate the operational component and disposed in a location where the work fluid leaking from the operational component will accumulate, a leak detection mechanism disposed within the work fluid accumulation area and monitoring the work fluid accumulation area for a work fluid leak accumulation of the work fluid leaking from the operational component, wherein the leak detection mechanism transmits a leak detection sensor signal in response to detecting the work fluid leak accumulation in the work fluid accumulation area, and a communication module. The work machine may further include a work machine controller operatively connected to the leak detection mechanism and the communication module, with the work machine controller being programmed to receive the leak detection sensor signal from the leak detection mechanism, and cause the communication module to transmit a work machine leak detected signal to a work machine monitoring center in response to receiving the leak detection sensor signal.

In another aspect of the present disclosure, a method for machine leak detection in a plurality of work machines is disclosed. The method may include in each of the plurality of work machines, monitoring a work fluid accumulation area within the work machine for a work fluid leak accumulation of a work fluid from an operational component of the work machine, detecting the work fluid leak accumulation of the work fluid leaking from the operational component of the work machine within the work fluid accumulation area, transmitting a work machine leak detected signal from the work machine to a work machine monitoring center in response to detecting the work fluid leak accumulation within the work fluid accumulation area, and outputting a sensory perceptible output of a leak status of the work machine at the work machine monitoring center in response to receiving the work machine leak detected signal from the work machine.

In a further aspect of the present disclosure, a machine leak detection system is disclosed. The machine leak detection system may include a work machine fleet comprising a plurality of work machines, a fleet monitoring center communicatively linked to each of the plurality of work machines of the work machine fleet, and a remote monitoring center communicatively linked to each of the plurality of work machines and to the fleet monitoring center. Each work machine may include a leak detection mechanism for detecting a work fluid leak accumulation of a work fluid leaking from an operational component, and to transmit a leak detection sensor signal in response to detecting the work fluid leak accumulation, a communication module, and a work machine controller operatively connected to the leak detection mechanism and the communication module. The work machine controller may be programmed to receive the leak detection sensor signal from the leak detection mechanism, and to cause the communication module to transmit a work machine leak detected signal. The remote monitoring center may be configured to receive the work machine leak detected signal from the communication module of the one of the plurality of work machines.

Additional aspects are defined by the claims of this patent.

### BRIEF DESCRIPTION OF THE DRAWINGS

FIG. 1 is a perspective view of an exemplary work machine in which machine leak detection in accordance with the present disclosure may be implemented;

FIG. 2 is a schematic view of an operational component of the work machine of FIG. 1, a corresponding work fluid accumulation area and an embodiment of a leak detection mechanism in accordance with the present disclosure;

FIG. 3 is the schematic view of FIG. 2 with a work fluid leaking from the operational component and creating a work fluid leak accumulation on a surface of the work fluid accumulation area;

FIG. 4 is a schematic view of the operational component of the work machine of FIG. 1, the work fluid accumulation area and an alternative embodiment of a leak detection mechanism in accordance with the present disclosure;

FIG. 5 is the schematic view of FIG. 4 with the work fluid leaking from the operational component and creating the work fluid leak accumulation on the surface of the work fluid accumulation area;

FIG. 6 is a schematic view of operational components and control system components of the work machine of FIG. 1 pertaining to machine leak detection in accordance with the present disclosure;

FIG. 7 is a schematic view of a plurality of fleets of the work machine of FIG. 1 and a remote monitoring center connected by a network; and

FIG. 8 is a flow diagram of an exemplary machine leak detection routine in accordance with the present disclosure.

### DETAILED DESCRIPTION

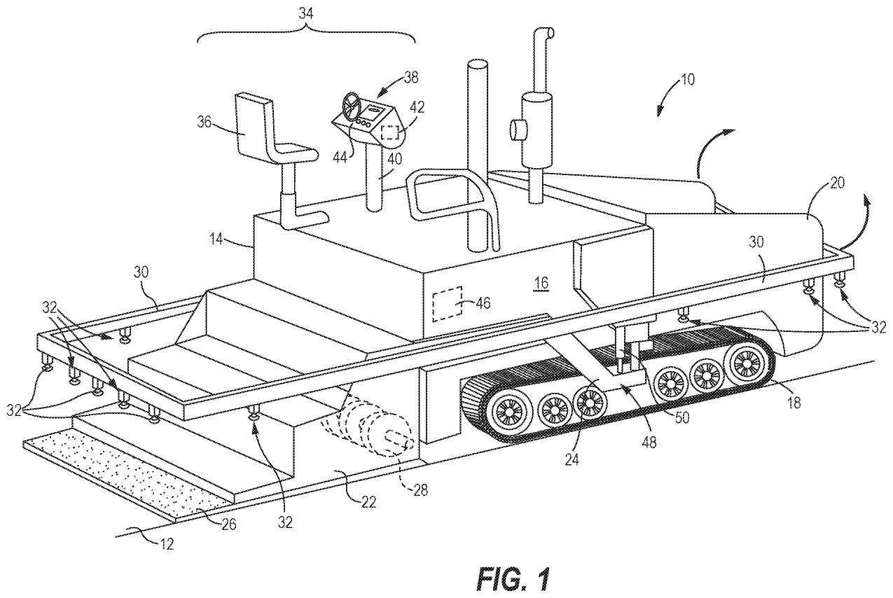

FIG. 1 is an illustration of an exemplary work machine 10 in the form of a paving machine in which machine leak detection in accordance with the present disclosure may be implemented. The paving machine 10 may spread paving material to form a layer of a paving material on a work surface 12, with exemplary paving materials that can be spread by the paving machine 10 including asphalt, concrete, and loose aggregate materials such as crushed gravel. The work machine 10 includes a tractor 14 having a power source 16, such as an engine or motor, one or more traction devices 18, and a hopper 20 for containing paving material. The traction devices 18 may be operatively coupled to the power source 16 by a transmission mechanism (not shown) to drive the traction devices 18 and propel the work machine 10. Although the traction devices 18 are shown in the figures as tracks, the traction devices 18 could alternatively be wheels or any other type of traction devices. The traction devices 18 could also be combinations of different types of traction devices. For example, the work machine 10 could include both tracks and wheels.

The illustrated work machine 10 also includes a screed 22 attached to the tractor 14 by tow arms 24 and towed behind the tractor 14 to spread and compact the paving material into a mat 26 on the work surface 12. The screed 22 may include one or more augers 28 for spreading the paving material to the lateral extents of the screed 22. In addition, the work machine 10 includes a sensor frame 30 attached to the screed 22 and/or to the tow arms 24. The sensor frame 30 may include one or more sensors 32 that may sense values of various parameters relating to the operation of the work machine 10, such as the height of the paving machine 10 at various locations, and temperatures of the paving material, the screed 22 and the mat 26.

The work machine 10 also includes an operator station 34 for one or more operators. The operator station 34 includes a seat 36 and an operation console 38 that may be mounted on a pedestal 40. The operator station 34 includes an operator station controller 42 as well as a user interface 44 for accepting user input and displaying information to the operator. The user interface 44 may have a combination of buttons, switches, dials, levers, touch screens and other control devices that may allow the operator to input commands to the operator station controller 42 for controlling the operation of the various components of the paving machine 10. The operator station controller 42 of the operator station 34 may be operatively connected to a work machine controller or engine control module (ECM) 46 to transfer operator control inputs to the work machine controller 46 and to receiving machine operation information to the displayed to the operator at the user interface 44.

The screed 22 spreads a pile of paving material from the hopper 20 evenly and compacts the paving material into the mat 26 on the work surface 12. The screed 22 is shown in the figures as a floating-type screed that is attached to the tractor 14 at tow points 48 by the tow arms 24. The height of the screed 22 may be adjusted by raising and/or lowering the tow arms 24 at the tow points 48 with screed height adjusters 50. The screed height adjusters 50 may be any suitable actuators, such as, for example, hydraulic cylinders. When the paving machine 10 is in motion, the screed 22 floats on a layer of paving material at a substantially consistent height relative to the height of the tow arms 24 at the tow points 48. The operator can adjust the height of the screed 22 during the paving job via appropriate controls at the operation console 38 that actuate the screed height adjusters 50.

The paving machine 10 illustrated in the drawing figures and described herein is exemplary of work machines 10 in which machine leak detection in accordance with the present disclosure may be implemented. Other types of work machines 10 contemplated by the inventors include backhoe loaders, cold planers, compactors, bulldozers, drills, excavators, material handlers, motor graders, skid steer and wheel loaders, and the like. Each of these work machines 10 is operated at least in part using work fluids that flow through operational components of the work machine 10 during operation and/or are stored in reservoirs within the work machine 10. For example, fuel is a work fluid that may be drawn from a fuel tank by a fuel pump and delivered to the power source 16 for combustion to drive the work machine 10. Lubricants such as engine oil may be provided to moving parts to reduce friction, while at the same time being circulated through heat exchanges to remove heat and filters to remove particulates that could cause abrasion on the moving parts. In some work machines, hydraulic elements such as hydraulic cylinders may utilize hydraulic fluid under pressure to drive the hydraulic elements to move components of the work machines 10, such as the screed height adjusters 50.

Much of the work fluid storage and flow occurs within the interior of the work machine 10. Consequently, unless the work fluid flows out onto the work surface 12 or spews out of the tractor 14, or causes changes in the color or odor of exhaust gases discharged from the work machine 10, work fluid leaks may not be apparent to the operators or other workers in the vicinity of the work machine 10 in real time. Some work fluid leakage may be acceptable, and even expected, and may pose no immediate harm to the performance or components of the work machine 10. In such cases, identifying the work fluid leakages during times when the work machine 10 is not in use or during scheduled maintenance operations may be acceptable. Other work fluid leakages are more immediately problematic and may require real time identification to ensure the work machine 10 functions optimally and without incurring damage as a result of the leakage, such as a leak causing an engine oil pan to drain. For problematic leakage situations, machine leak detection in accordance with the present disclosure may be implemented.

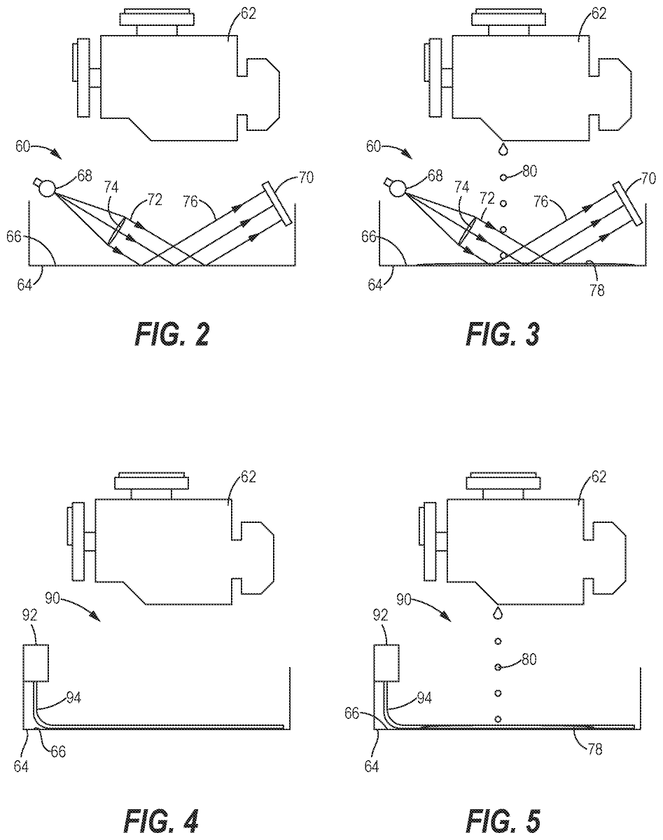

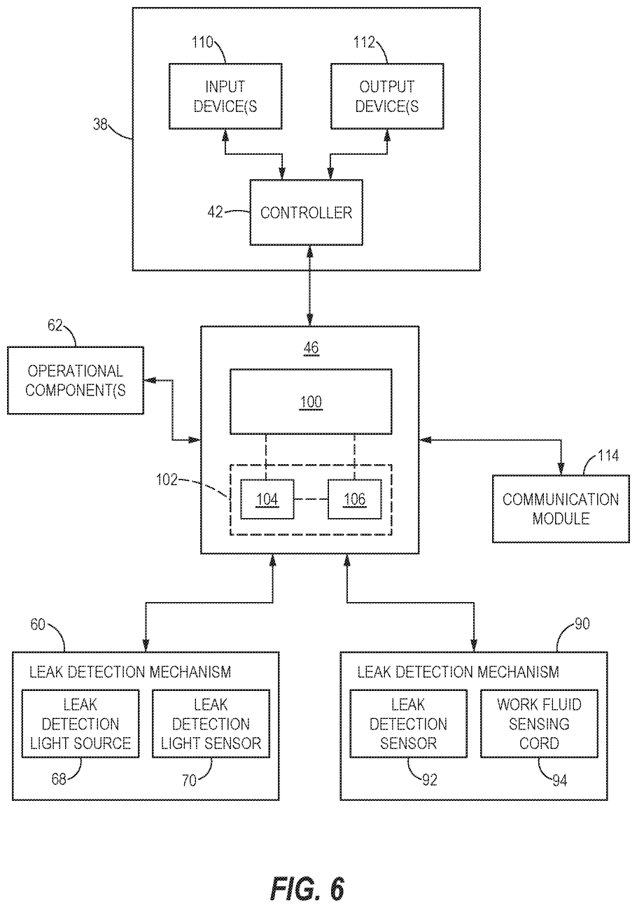

FIGS. 2 and 3 schematically illustrate one embodiment of a leak detection mechanism 60 in accordance with the present disclosure that may be implemented in the work machine 10. The leak detection mechanism 60 may detect leaks of work fluid from an operational component 62 of the work machine 10. The operational component 62 may be any component of the work machine 10 having a work fluid stored within or flowing through the operational component 62. For example, the operational component 62 may be an oil pan of an engine, a hydraulic cylinder, a fuel or oil pump, a conduit for fuel, engine oil or hydraulic fluid, a work fluid reservoir, or the like. The operational component 62 may have an associated work fluid accumulation area 64 proximate thereto where work fluid leaking from the operational component 62 will accumulate within the work machine 10. The work fluid accumulation area 64 may be immediately below the operational component 62 as schematically illustrated, or may be in another known location to which work fluid leaking from the operational component 62 will flow during operation of the work machine 10.

The leak detection mechanism 60 may be disposed within the work fluid accumulation area 64. In the illustrated embodiment, the leak detection mechanism 60 may detect light reflecting off a surface of a work fluid as it accumulates on a surface 66 of the work fluid accumulation area 64. To create and detect reflected light, the leak detection mechanism 60 may include a leak detection light source 68 and a leak detection light sensor 70. The leak detection light source 68 projects a leak detection light 72 onto the surface 66 of the work fluid accumulation area 64. If necessary, a lens 74 may be provided to focus the leak detection light 72 on a particular location on the surface 66. With or without work fluid on the surface 66, a portion of the leak detection light 72 is reflected in a reflected leak detection light 76 in the direction of the leak detection light sensor 70. The leak detection mechanism 60 or software at the work machine controller 46 controlling the leak detection mechanism 60 may be calibrated to distinguish between the characteristics of the reflected leak detection light 76 directly reflected from the surface 66 (FIG. 2) versus the reflected leak detection light 76 reflected from a surface of a work fluid leak accumulation 78 on the surface 66 that collects during leakage of a work fluid 80 from the operational component 62 (FIG. 3).

The leak detection light sensor 70 may have various forms depending on the requirements of the implementation. For example, the leak detection mechanism 60 may have a gloss meter-type configuration where the leak detection light sensor 70 is a filtered detector that measures an amount of reflected light relative to a reference gloss unit (GU). Reflected leak detection light 76 off the surface 66 may be less than the reference GU, and the work fluid leak accumulation 78 may be detected when the amount of reflected leak detection light 76 is greater than the reference GU. Configuration and positioning of the leak detection light source 68 and the leak detection light sensor 70 for a particular combination of the surface 66 of the work fluid accumulation area 64 and the work fluid 80 in the work fluid leak accumulation 78 will be within the capabilities of those skilled in the art.

In alternative embodiments, other technologies may be implemented for detecting the reflected leak detection light 76. For example, the filtered detector described above may be replaced by a smart camera that is also capable of detecting the amount of reflected leak detection light 76 from the surface 66 and the work fluid leak accumulation 78. Use of a smart camera may enable the implementation of additional functionality into the leak detection mechanism 60 for identifying and responding to work fluid leaks through analysis of captured image data. For example, analysis of the image data may determine a size of the work fluid leak accumulation 78 and the rate at which the work fluid leak accumulation 78 is increasing. For small work fluid leak accumulations 78 and slow leaks of the work fluid 80, it may be sufficient to log of the occurrence of the leak so that it may be inspected and stopped when the work machine 10 is not in use. Larger work fluid leak accumulation 78 or larger leaks may trigger the work machine controller 46 to alter the operation of the leaking operational component 62 or the work machine 10. For example, depending on the leak severity, the operational component 62 may be shut down to prevent damage, or the work machine 10 may be diverted to a maintenance area where the leak can be addressed. Additional processing in the leak detection mechanism 60 is contemplated.

FIGS. 4 and 5 illustrate an alternative embodiment of a leak detection mechanism 90 for detecting leaks of the work fluid 80 from the operational component 62. In the leak detection mechanism 90, a leak detection sensor 92 is mounted at the work fluid accumulation area 64 and has a work fluid sensing cord 94 attached thereto. The work fluid sensing cord 94 is laid out on the surface 66 of the work fluid accumulation area 64 where the work fluid leak accumulation 78 will collect. As the work fluid 80 (FIG. 5) leaks from the operational component 62, the work fluid leak accumulation 78 will come into contact with the work fluid sensing cord 94 and provide an electrical connection to close a circuit that is detected at the leak detection sensor 92. The connection, and correspondingly the occurrence of the leak, is communicated to the work machine controller 46 so that appropriate responsive actions may be taken.

Those skilled in the art will understand that the leak implemented at multiple locations within the work machine 10 for identification of leaks from various operational components 62 where leak detection is desirable. In such implementations, the leak detection mechanisms 60, 90 and the work machine controller 46 may be configured to distinguish between the monitored operational components 62 so that the leak detection information is meaningful to the operator of the work machine 10 and to maintenance personnel. As is further apparent to the person skilled in the art, different types of work machines 10 will have different combinations of leak detection mechanisms 60, 90 monitoring different types of operational components 62 as may be implemented in the work machines 10.

Referring now to FIG. 3, exemplary operational components 62 and control system components of the work machine 10 pertaining to machine leak detection in accordance with the present disclosure are illustrated. The work machine controller 46 may include a microprocessor 100 for executing a specified program, which controls and monitors various functions associated with the work machine 10. The microprocessor 100 includes a memory 102, such as read only memory (ROM) 104, for storing a program or programs, and a random access memory (RAM) 106 which serves as a working memory area for use in executing the program(s) stored in the memory 102. Although the work machine controller 46 is shown, it is also possible and contemplated to use other electronic components such as a microcontroller, an ASIC (application specific integrated circuit) chip, or any other integrated circuit device.

As discussed above, the work machine controller 46 may be operatively connected to the operator station controller 42 of the operation console 38 for transfer of operator control inputs from the operator station controller 42 to the work machine controller 46, and for receiving machine operation information from the work machine controller 46 and the operator station controller 42 and displaying the information to the operator at the user interface 44. The operation console 38 may include input devices 110 at the user interface 44, such as buttons, switches, dials, levers, touch screens and other control devices, that may be operatively connected to the operator station controller 42 to allow the operator to input commands to the operator station controller 42 for controlling the operation of the various components and systems of the work machine 10. The operation console 38 may further include output devices 112 at the user interface 44, such as monitors, touch screens, lights, speakers and the like that are capable of producing a sensory perceptible output to the operator of information relating to the operation and status of the work machine 10 that is provided by the work machine controller 46.

While the input devices 110 and the output devices 112 are illustrated and described herein as being located at the operation console 38, those skilled in the art will understand that alternative or additional input and output devices may be located within the operator station 34 at other locations that are accessible to the operator positioned in the seat 36 as necessary based on the ergonomic and functional designs of the particular work machine 10 in which machine leak detection is implemented. Some or all control functions of the work machine 10 may also be performed by an operator at the ground level or at other locations on the work machine 10 via additional user interfaces (not shown) positioned around the work machine 10. Such functions may include speed control, a transmission control, screed temperature and height control, auger speed and height control, conveyor speed control and hopper position control. The secondary user interfaces may further include output devices similar to the output devices 112 discussed above.

While the discussion provided herein relates to the functionality of the machine leak detection, the work machine controller 46 is typically configured to control other aspects of operation of other systems of the work machine 10. Moreover, the work machine controller 46 may refer collectively to multiple control and processing devices across which the functionality of the machine leak detection system and other operational systems of the work machine 10 may be distributed. For example, portions of the functionality of machine leak detection may be performed at remote computing devices or monitoring locations such as those discussed further below that are operatively connected to the work machine controller 46 by a communication module 114 of the work machine 10. The remote computing devices or monitoring locations may be in a centralized location for an enterprise utilizing the work machines 10 to perform tasks at a worksite. The remote computing devices or monitoring locations may be operatively connected to exchange information as necessary to control and monitor the operation of the work machine 10. Other variations in consolidating and distributing the processing of the work machine controller 46 as described herein are contemplated as having use in machine leak detection systems in accordance with the present disclosure.

The work machine controller 46 may be operatively connected to the operational component(s) 62 such as engines, motors, pumps, valves and actuators to the extent that the operational component(s) are controlled by the work machine controller 46 or provide data to the work machine controller 46 for monitoring and control of the work machine 10. Such connections may not exist for certain types of operational components 62 such as work fluid reservoirs and conduits that only store or transport the work fluid 80 but do not otherwise actively participate in the operation of the work machine 10. Those skilled in the art will be familiar with the exchange of information and control signals between the work machine controller 46 and the operational components 62 to control the operation of the operational components 62 and the functioning of the work machine 10 without the necessity of further elaboration herein except as necessary to describe machine leak monitoring in accordance with the present disclosure.

The leak detection mechanisms 60, 90 that are provided in a particular work machine 10 are operatively connected to the work machine controller 46 for control of monitoring the corresponding work fluid accumulation areas 64. For the leak detection mechanism 60, for example, the work machine controller 46 may transmit signals to the leak detection light source 68 to project the leak detection light when the associated operational component 62 is operating or at a time during operation of the work machine 10 when leaks are most likely to occur. In alternative embodiments, the leak detection light source 68 may turn on independent of signals from the work machine controller 46, such as any time the work machine 10 is started up for operation. The leak detection light sensor 70 may be configured to provide a continuous or periodic leak detection sensor signal to the work machine controller 46 containing a reflected leak detection light value indicating an amount of the reflected leak detection light 76 detected at the leak detection light sensor 70. When the leak detection sensor signal is received, the work machine controller 46 may evaluate the reflected leak detection light value to determine if a work fluid leak accumulation 78 is present in the work fluid accumulation area 64. In alternative embodiments, the leak detection light sensor 70 may be configured to transmit the leak detection sensor signal only when the reflected leak detection light value is greater than a predetermined minimum value indicating the occurrence of a work fluid leak that, at a minimum, should be logged for further inspection. In the leak detection mechanism 90, the leak detection sensor 92 may be configured to transmit the leak detection sensor signal to the work machine controller 46 when the leak detection sensor 92 senses the closing of the circuit caused by the work fluid 80 in the work fluid leak accumulation 78 contacting the work fluid sensing cord 94.

### INDUSTRIAL APPLICABILITY

In basic implementations, upon the detection of a leak from an operational component 62, the work machine controller 46 may cause a sensory perceptible leak output at one of the output devices 112 of the operation console 38 to alert the operator. The leak output may be a generic notice that a leak is occurring or may be more specific to the operational component 62 that is leaking. The leak detected output may further include a severity of the leak as may be determined by sophisticated equipment such as the smart camera discussed above, and may provide the operator with a suggested or required corrective action to take, such as shutting down the leaking operational component 62, shutting down the work machine 10, reporting the leak is a maintenance issue, or the like. In more sophisticated implementations, the work machine controller 46 may be configured to automatically execute the corrective actions when the work fluid leak is detected and the severity of the leak is assessed. Execution of the corrective action may also include providing the leak detected output to the operator to alert them to the leak and the corrective action taken.

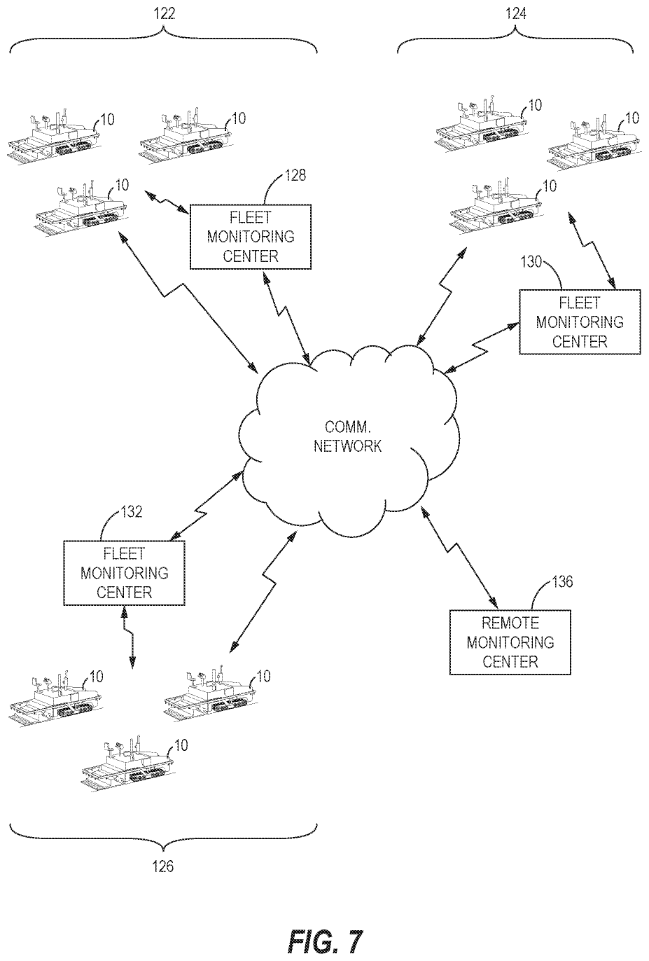

In other implementations, machine leak detection in accordance with the present disclosure may be a part of a broader monitoring and control strategy for an enterprise to operate a fleet of work machines 10 at one or more worksites. FIG. 7 illustrates a machine leak monitoring system 120 for monitoring work machines 10 for one or more enterprises. In the machine leak monitoring system 120, the work machines 10 may be grouped into fleets 122, 124, 126 of work machines 10 that may be controlled and monitored by fleet monitoring centers 128, 130, 132, respectively. Such arrangements may be advantageous where some or all work machines 10 are autonomous machines that operate without onboard operators. The fleet monitoring centers 128, 130, 132 are capable of communicating with the work machines 10 of the corresponding fleet 122, 124, 126 via the communication modules 114 of the work machines 10. The fleet monitoring centers 128, 130, 132 and the work machines 10 may also be able to communicate with other machines, devices and systems via a communication network 134 such as the Internet or the like. Using the communication network 134, communications may be established with a remote monitoring center 136 that is integrated into the machine leak monitoring system 120 as discussed further below.

The fleets 122, 124, 126 of work machines 10 may be part of a single enterprise, and each fleet 122, 124, 126 may represent a portion of the enterprise's assets committed to a particular client or worksite. Alternatively, each fleet 122, 124, 126 may be owned by a different enterprise. The remote monitoring center 136 may be operated by an entity that is independent of the enterprise(s) that own and operate the fleets 122, 124, 126. For example, the remote monitoring center 136 may be a facility operated by manufacturer of the work machines 10, and the manufacturer may offer machine leak monitoring as illustrated and described herein as a subscription service to its customers as an alternative to selling software and providing training for performing the leak monitoring functions at the fleet monitoring centers 128, 130, 132. Depending on the particular implementation, there may be at least 3 points of notification of the occurrence of a leak at an operational component 62: at the work machine 10 where the leak occurs, at the corresponding fleet monitoring center 128, 130, 132, and at the remote monitoring center 136.

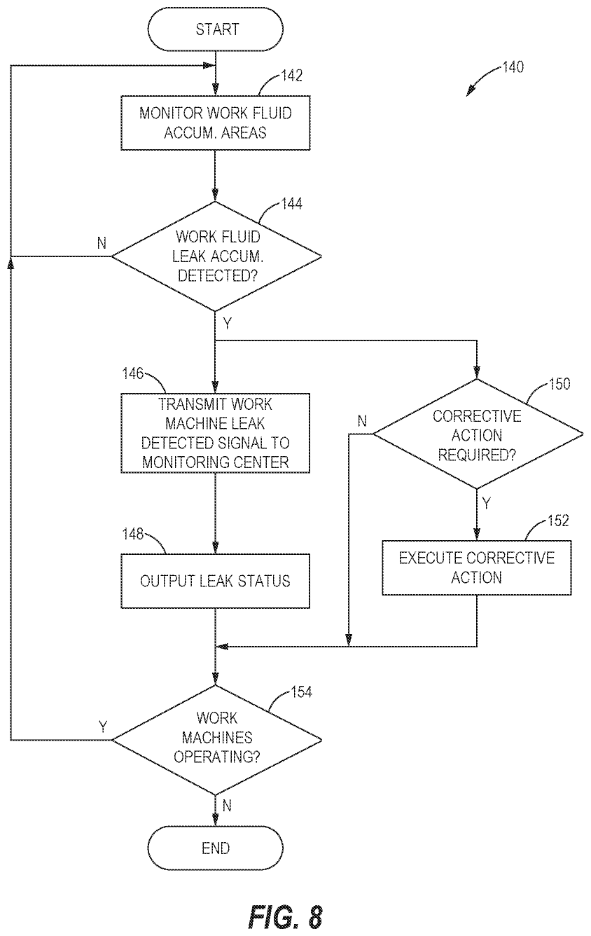

FIG. 8 illustrates an exemplary machine leak detection routine 140 that may be implemented in the machine leak monitoring system 120 or variations thereof. The machine leak detection routine 140 may begin at a block 142 where the work machine controllers 46 of the operating work machines 10 monitor the work fluid accumulation areas 64 for leaks of work fluid 80 from the operational components 62. The leak detection mechanisms, such as the leak detection mechanisms 60, 90, function as described above under the control of the work machine controllers 46 to determine when leaks of work fluid 80 cause work fluid leak accumulations 78 in the work fluid accumulation areas 64. As the monitoring is performed, control may pass to a block 144 where the work machine controllers 46 determine whether a work fluid leak accumulations 78 are detected. If work fluid leak accumulations 78 are not detected, control may pass back to the block 142 to continue monitoring the work fluid accumulation areas 64.

If one of the work machine controllers 46 receives a leak detection sensor signal from the leak detection mechanism 60, 90 at the block 144, and the leak detection sensor signal indicates the presence of a work fluid leak accumulations 78, control may pass to a block 146 where the work machine controller 46 may cause the communication module 114 to transmit a work machine leak detected signal to the corresponding fleet monitoring center 128, 130, 132 and/or the remote monitoring center 136, depending on the configuration of the machine leak monitoring system 120. The work machine leak detected signal may contain information necessary to identify the source of the leak and the severity, such as identifiers for the enterprise, the fleet, the work machine, and the operational component, a leak flow rate if known, and other relevant information. Where machine leak monitoring is an internal process for the enterprise, the work machine leak detected signal is transmitted to the appropriate fleet monitoring center 128, 130, 132. Where machine leak monitoring is outsourced, the work machine leak detected signal may be transmitted over the communication network 134 to the remote monitoring center 136. In the outsourced configuration, the remote monitoring center 136 may be configured to respond to the work machine leak detected signal by transmitting an appropriate notification signal back to the corresponding fleet monitoring center 128, 130, 132.

After or contemporaneous with the transmission of the work machine leak detected signal, a leak status may be output to the appropriate personnel at a block 148. For example, the work machine controller 46 may cause the leak status to be displayed to the operator of the work machine 10 at the output device 112. The display may be as basic as a warning light or audible output from the speaker, or more detailed with information as to the operational component 62 that is leaking, the leak severity or flow rate, and recommended or required corrective actions to be taken. Similar information may be displayed at user interfaces of the corresponding fleet monitoring center 128, 130, 132 or the remote monitoring center 136. Alternative or additional leak status output may include adding information about the leak to a maintenance log for follow-up inspection and repair at the appropriate time.

In parallel to the notifications occurring at the blocks 146, 148, control may pass to a block 152 determine whether a corrective action is required at the present time for the leak. The evaluation and determination may be performed at the work machine controller 46, or the processing may be performed remotely at the fleet monitoring center 128, 130, 132 or the remote monitoring center 136. If it is determined that no corrective action is required at the block 150, operation of the work machine 10 and the leaking operational component 62 may continue unchanged. If corrective actions are required at the block 150, control may pass to a block 152 where the work machine controller 46 may execute the corrective action and modify the operation of the work machine 10. In some situations, shutting down the leaking operational component 62 will allow the work machine 10 to continue operation in some fashion. Severe leaks may cause the work machine controller 46 to shut down the work machine 10 so that maintenance may be performed before further operation. In other cases, the work machine 10 may be taken out of service and navigated out of the work area, possibly to a maintenance area. Other appropriate corrective actions will be apparent to those skilled in the art.

After the work machine leak detected signal is transmitted (block 146), the leak status is output (block 148), and corrective actions, if any, are executed (block 152), control may pass to a block 154 to determine whether any work machines 10 in the machine leak monitoring system 120 are currently operating. If any work machines 10 are operating, control may pass back to the block 142 to continue monitoring the work fluid accumulation areas 64 of the operating work machines 10. If no work machines 10 are operating, machine leak monitoring may be unnecessary, and the machine leak detection routine 140 may terminate.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. A work machine comprising:
an operational component containing a work fluid of the work machine;
a work fluid accumulation area proximate the operational component and disposed in a location where the work fluid leaking from the operational component will accumulate;
a leak detection mechanism disposed within the work fluid accumulation area and monitoring the work fluid accumulation area for a work fluid leak accumulation of the work fluid leaking from the operational component, wherein the leak detection mechanism transmits a leak detection sensor signal in response to detecting the work fluid leak accumulation in the work fluid accumulation area;
a communication module; and
a work machine controller operatively connected to the leak detection mechanism and the communication module, the work machine controller being programmed to:
receive the leak detection sensor signal from the leak detection mechanism, and
cause the communication module to transmit a work machine leak detected signal to a work machine monitoring center in response to receiving the leak detection sensor signal.

2. The work machine according to claim 1, wherein the leak detection mechanism comprises:
a leak detection light source projecting a leak detection light into the work fluid accumulation area; and
a leak detection light sensor operatively connected to the work machine controller and positioned within the work fluid accumulation area, wherein the leak detection light sensor outputs the leak detection sensor signal to the work machine controller in response to detecting a reflected leak detection light caused by the leak detection light reflecting off the work fluid in the work fluid leak accumulation.

3. The work machine according to claim 1, wherein the leak detection mechanism comprises:
a leak detection sensor operatively connected to the work machine controller and mounted proximate the work fluid accumulation area; and
a work fluid sensing cord operatively connected to the leak detection sensor and positioned within the work fluid accumulation area, wherein the leak detection sensor outputs the leak detection sensor signal to the work machine controller in response to a contact between the work fluid in the work fluid leak accumulation and the work fluid sensing cord.

4. The work machine according to claim 1, wherein the work machine controller is programmed to disable the operational component in response to receiving the leak detection sensor signal.

5. The work machine according to claim 1, wherein the work machine controller is programmed to cause the work machine to navigate from a work area to a maintenance area in response to receiving the leak detection sensor signal.

6. The work machine according to claim 1, comprising an output device operatively connected to the work machine controller, wherein the work machine controller is programmed to cause the output device to display a leak status of the work machine in response to receiving the leak detection sensor signal.

7. The work machine according to claim 1, comprising:
a second operational component containing a second work fluid of the work machine;
a second work fluid accumulation area proximate the second operational component and disposed in a second location where the second work fluid leaking from the second operational component will accumulate;
a second leak detection mechanism operatively connected to the work machine controller and disposed within the second work fluid accumulation area and monitoring the second work fluid accumulation area for a second work fluid leak accumulation of the second work fluid leaking from the second operational component, wherein the second leak detection mechanism transmits a second leak detection sensor signal in response to detecting the second work fluid leak accumulation in the second work fluid accumulation area,
wherein the work machine controller is being programmed to:
receive the second leak detection sensor signal from the second leak detection mechanism, and
cause the communication module to transmit a second work machine leak detected signal to the work machine monitoring center in response to receiving the second leak detection sensor signal.

8. A method for machine leak detection in a plurality of work machines, the method for machine leak detection comprising:
in each of the plurality of work machines, monitoring a work fluid accumulation area within the work machine for a work fluid leak accumulation of a work fluid from an operational component of the work machine;
detecting the work fluid leak accumulation of the work fluid leaking from the operational component of the work machine within the work fluid accumulation area;
transmitting a work machine leak detected signal from the work machine to a work machine monitoring center in response to detecting the work fluid leak accumulation within the work fluid accumulation area; and
outputting a sensory perceptible output of a leak status of the work machine at the work machine monitoring center in response to receiving the work machine leak detected signal from the work machine.

9. The method for machine leak detection according to claim 8, wherein monitoring the work fluid accumulation area comprises projecting a leak detection light into the work fluid accumulation area, and wherein detecting the work fluid leak accumulation comprises sensing a reflected leak detection light caused by the leak detection light reflecting off the work fluid in the work fluid leak accumulation.

10. The method for machine leak detection according to claim 8, wherein monitoring the work fluid accumulation area comprises disposing a work fluid sensing cord within the work fluid accumulation area, and wherein detecting the work fluid leak accumulation comprises sensing a contact between the work fluid in the work fluid leak accumulation and the work fluid sensing cord.

11. The method for machine leak detection according to claim 8, comprising disabling the operational component in response to detecting the work fluid leak accumulation within the work fluid accumulation area.

12. The method for machine leak detection according to claim 8, causing the work machine to navigate from a work area to a maintenance area in response to detecting the work fluid leak accumulation within the work fluid accumulation area.

13. The method for machine leak detection according to claim 8, comprising causing the work machine monitoring center to transmit a machine leak detected signal to a fleet monitoring center for the plurality of work machines in response to receiving the work machine leak detected signal at the work machine monitoring center.

14. The method for machine leak detection according to claim 8, comprising outputting the leak status of the work machine to an operator of the work machine in response to detecting the work fluid leak accumulation within the work fluid accumulation area.

15. A machine leak detection system, comprising:
a work machine fleet comprising:
a plurality of work machines, wherein each work machine comprises:
a leak detection mechanism for detecting a work fluid leak accumulation of a work fluid leaking from an operational component, and to transmit a leak detection sensor signal in response to detecting the work fluid leak accumulation,
a communication module, and
a work machine controller operatively connected to the leak detection mechanism and the communication module, wherein the work machine controller is programmed to:
receive the leak detection sensor signal from the leak detection mechanism, and
cause the communication module to transmit a work machine leak detected signal, and
a fleet monitoring center communicatively linked to each of the plurality of work machines of the work machine fleet; and
a remote monitoring center communicatively linked to each of the plurality of work machines and to the fleet monitoring center, wherein the remote monitoring center is configured to receive the work machine leak detected signal from the communication module of the one of the plurality of work machines.

16. The machine leak detection system according to claim 15, wherein the remote monitoring center transmits a fleet leak detected signal to the fleet monitoring center in response to receiving the work machine leak detected signal from the communication module of the one of the plurality of work machines.

17. The machine leak detection system according to claim 15, wherein the leak detection mechanism of at least one of the plurality of work machines comprises:
a leak detection light source projecting a leak detection light into a work fluid accumulation area proximate the operational component; and
a leak detection light sensor disposed within the work fluid accumulation area, wherein the leak detection light sensor outputs the leak detection sensor signal to the work machine controller in response to detecting a reflected leak detection light caused by the leak detection light reflecting off the work fluid in the work fluid leak accumulation.

18. The machine leak detection system according to claim 15, wherein the leak detection mechanism of at least one of the plurality of work machines comprises:
a leak detection sensor operatively connected to the work machine controller and mounted proximate a work fluid accumulation area proximate the operational component; and
a work fluid sensing cord operatively connected to the leak detection sensor and positioned within the work fluid accumulation area proximate the operational component, wherein the leak detection sensor outputs the leak detection sensor signal to the work machine controller in response to a contact between the work fluid in the work fluid leak accumulation and the work fluid sensing cord.

19. The machine leak detection system according to claim 15, comprising:
a second work machine fleet comprising:
a second plurality of work machines, and
a second fleet monitoring center communicatively linked to each of the second plurality of work machines of the second work machine fleet,
wherein the remote monitoring center is configured to receive the work machine leak detected signal from the communication module of the one of the second plurality of work machines.

20. The machine leak detection system according to claim 15, wherein the work machine controller of each of the plurality of work machines in the work machine fleet is programmed to change an operation of the work machine in response to receiving the leak detection sensor signal from the leak detection mechanism.
